(19) United States
(12) Patent Application Publication
(10) Pub. No.: US 2020/0217928 A1
(43) Pub. Date: Jul. 9, 2020

(54) DETECTING MISALIGNMENT

(71) Applicant: ZF AUTOMOTIVE UK LIMITED, Solihull, West Midlands (GB)

(72) Inventors: Robert Pinnock, Birmingham, West Midlands (GB); Adam Heenan, Chesterfield, Derbyshier (GB); Emst Casaban, Solihull, West Midlands (GB); Navya Ramuni, Shirley , Solihull, West Midlands (GB); Martin Thompson, Solihull, West Midlands (GB); Martin Rändler, Immennstaad (DE); Martin Hahn, Ebenweiler (DE)

(73) Assignee: ZF Friedrichshafen AG, Friedrichshafen (DE)

(21) Appl. No.: 16/647,582

(22) PCT Filed: Sep. 18, 2018
(86) PCT No.: PCT/GB2018/052650

§ 371 Date: Mar. 16, 2020

(30) Foreign Application Priority Data
Sep. 18, 2017 (GB) 1714979.0

(51) Int. Cl. G01S 7/40; G01S 13/86

(52) U.S. Cl. CPC G01S 7/40; G01S 13/86

(57) ABSTRACT

Apparatus for detecting misalignment of a radar unit (2) of a vehicle (3), the apparatus comprising: an accelerometer (4) arranged to determine the acceleration of the radar unit (2) along three axes, and having an output for a signal indicative of the acceleration; and a processor arranged coupled to the output of the accelerometer; in which the processor is arranged to determine the misalignment based on the acceleration measured by the accelerometer (4), and in which the determination of the misalignment is made: about two axes, if the vehicle (3) is stationary; and about a third axis perpendicular to the two axes when the vehicle is moving.

This invention relates to apparatus and methods for detecting misalignment of a radar unit of a vehicle.

It is known to provide radar units in vehicles, particularly as part of systems such as adaptive cruise control and the like. Such systems have to be accurately aligned in the vehicle (as discussed, for example, in the PCT patent application published as WO2016/071696).

However, such systems can become misaligned following, for example, a minor crash event, especially when the “crash” occurs when the driver is not present, such as may happen when the parked vehicle is bumped into by another vehicle (e.g. in a car park or on-street parking situation). In such cases, using the current software-based processes for identifying radar unit misalignment may mean that the vehicle is driven for some considerable distance before the radar is able to recalibrate itself, or the driver is warned that the system is faulty.

As such, it is desirable to be able to establish, within a few seconds of driving off from stand-still, when radar realignment/recalibration or driver warning is necessary.

We are aware of U.S. Pat. No. 9,366,751, which discloses a radar unit having an integral 3-axis accelerometer measuring longitudinal, lateral, and vertical linear accelerations. The acceleration measurements from the 3-accelerometer mounted in the radar unit are compared with those measured by a separate 3-axis accelerometer mounted at (or close to) the vehicle's centre of gravity. In ideal alignment conditions and with ideal accelerometer calibration, the accelerations measured by both accelerometers should match. In the presence of misalignment of the radar unit, one or more of the acceleration signals will not match between the two accelerometers.

When the degree of misalignment is not too great, an appropriate amount of alignment compensation can then be applied to the processed radar signals. For cases where the detected misalignment is greater than a threshold the radar unit is disabled and a warning message is sent to the driver.

However, this system relies on the vehicle being in motion to work. One reason for this is that azimuthal (yaw) angular misalignment cannot be detected by a static 3-axis accelerometer (because the only acceleration acting on the accelerometer in the static case is that due to gravity, and the component of this acting on a laterally-aligned accelerometer axis is not changed by a purely azimuthal rotation). Hence, to date this type of misalignment requires the vehicle to be moving if a 3-axis accelerometer is used as the detection means.

According to a first aspect of the invention, there is provided apparatus for detecting misalignment of a radar unit of a vehicle, the apparatus comprising:
an accelerometer arranged to determine the acceleration of the radar unit along three axes, and having an output for a signal indicative of the acceleration; and
a processor arranged coupled to the output of the accelerometer;
   in which the processor is arranged to determine the misalignment based on the acceleration measured by the accelerometer, and in which the determination of the misalignment is made:
about two axes, if the vehicle is stationary; and
about a third axis perpendicular to the two axes when the vehicle is moving.

As such, we have appreciated that, rather than simply not making any measurements when the vehicle is stationary, it is possible to make use of the information about the two axes. The information about the third axis can then be added once the vehicle moves. Typically, the two axes will be perpendicular to each other, and the third axis may be generally vertical.

The processor may be arranged so as to not determine the misalignment about the third axis when the vehicle is stationary. It may also be arranged so as to determine the misalignment about the two axes when the vehicle is moving, such that the misalignment about all three axes (the two axes and the third axis) is determined with the vehicle in motion.

The processor may have an input for an indication whether the vehicle is moving, such as the output of a vehicle speed sensor. Alternatively, the processor may be arranged to determine from the accelerometer when the vehicle is moving.

In accordance with a second aspect of the invention, there is provided a vehicle having a radar unit and the apparatus of the first aspect of the invention attached thereto, in which the accelerometer is attached to or integrated in the radar unit.

The vehicle may be provided with a further accelerometer coupled to the vehicle and able to determine the acceleration of the vehicle about three axes, with an output of the further accelerometer being coupled to the processor and the processor arranged to determine the misalignment based upon the acceleration of the vehicle.

According to a third aspect of the invention, there is provided a method of detecting misalignment of a radar unit of a vehicle, comprising determining the acceleration of the radar unit along three axes, and determining the misalignment based on the acceleration, in which the determination of the misalignment is made:
about two axes, if the vehicle is stationary; and
about a third axis perpendicular to the two axes when the vehicle is moving.

As such, we have appreciated that, rather than simply not making any measurements when the vehicle is stationary, it is possible to make use of the information about the two axes. The information about the third axis can then be added once the vehicle moves. Typically, the two axes will be perpendicular to each other, and the third axis may be generally vertical.

The method may comprise not determining the misalignment about the third axis when the vehicle is stationary. It may also comprise determining the misalignment about the two axes when the vehicle is moving, such that the misalignment about all three axes (the two axes and the third axis) is determined with the vehicle in motion.

The method may comprise determining from the accelerometer when the vehicle is moving, or using a vehicle speed sensor to so determine.

The method may comprise using a further accelerometer coupled to the vehicle to determine the acceleration of the vehicle about three axes, and determining the misalignment based upon the acceleration of the vehicle.

There now follows description of an embodiment of the invention, described with reference to the accompanying drawings, in which:

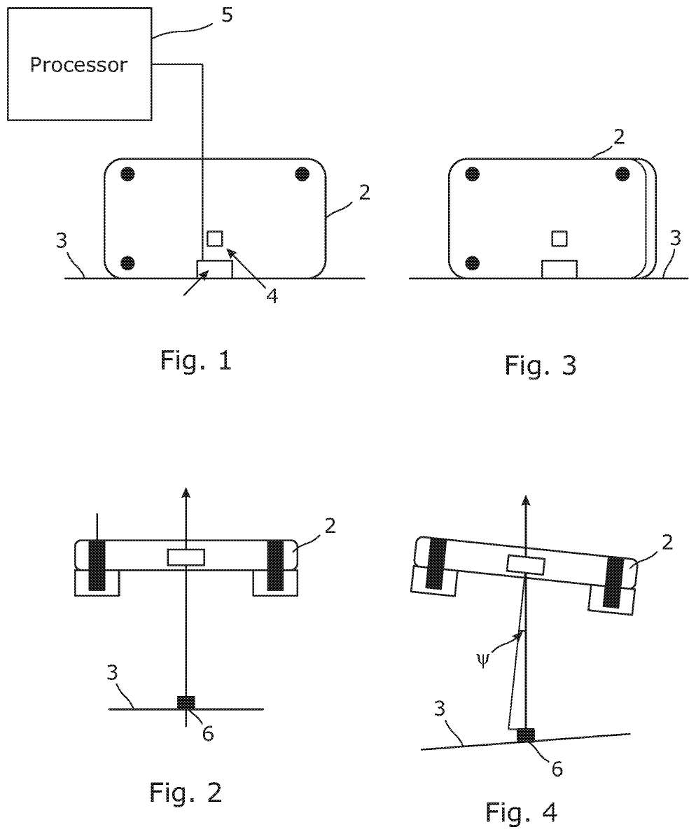

FIG. 1 is an elevation of a radar unit with a misalignment detection apparatus in accordance with an embodiment of the invention;

FIG. 2 is a plan view of the radar unit of FIG. 1;

FIGS. 3 and 4 are corresponding views of the radar unit of FIG. 1 to which a misalignment has been applied; and

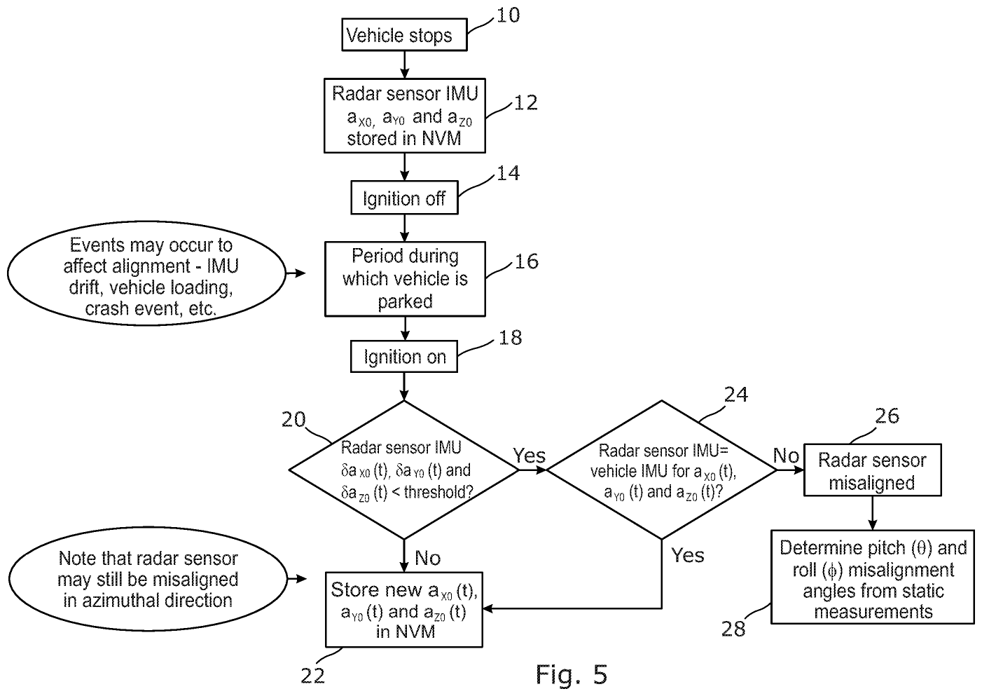

FIG. 5 is a flow chart showing the operation of the radar unit of FIG. 1.

The accompanying figures show an embodiment of the invention, which uses an accelerometer 4 whether a radar unit 2 has been misaligned.

Typically, the radar unit 2 will be carefully aligned relative to the vehicle 3 on manufacturing of the vehicle 3, with its position being calibrated. It is desirable to know, typically within a few seconds of starting the vehicle, before it is driven away, whether that careful positioning has been disturbed (e.g. by an impact).

As such, the radar unit comprises a three-axis accelerometer 4 coupled to a processor 5. This accelerometer measures the acceleration of the radar unit along three axes—typically two perpendicular horizontal axes and one vertical axis. The apparatus is further provided with a vehicle accelerometer 6 which is mounted on the vehicle 3 spaced apart from the radar unit 2 and measures the acceleration of the vehicle about three axes—again typically two perpendicular horizontal axes and one vertical axis. The output of the vehicle accelerometer 6 is also coupled to the processor 5.

Thus, by comparing the output of the two accelerometers 4, 6 at different times with the vehicle stationary, it is possible to determine whether there has been misalignment about any horizontal axis. In particular, pitch and roll information is typically available. It is not possible whilst the vehicle is stationary to detect with the accelerometers any misalignment that is purely about the vertical axis, as whilst the vehicle is stationary, the only force acting on the vehicle is gravity, and a rotation about a vertical axis will not change the direction in which gravity pulls the accelerometers. However, we have appreciated that the other two axes are available, and so whilst the vehicle is stationary, the misalignments about the two available axes are determined.

Once the vehicle drives away, there will be other accelerations other than purely gravity that act upon the accelerometers 4, 6. As such, it will then be possible to determine the misalignment angles about all three axes, pitch, roll and yaw.

As such, the following method can be followed.
1. Upon ignition on, detect any pitch and roll angular misalignment of the radar sensor module that has occurred since the previous ignition off (based on the effect of gravitational acceleration on the accelerometer axes), and implement any corrections required (or put the system into degraded/non-functioning mode with driver warning if too much misalignment has occurred).
2. Upon driving off, and within a few (approximately 5) seconds, detect any azimuthal angular misalignment of the radar sensor that has occurred since the previous ignition off, and again implement corrections or system functionality changes as required.

The reason for the two-part process is that, using only an accelerometer 4 comprising three linear accelerometer axes, it is not possible to detect azimuthal rotation purely from measurement of gravitational acceleration: only pitch and roll rotations can be determined. Hence, azimuthal rotational misalignment must be detected from lateral accelerations of the vehicle once it is moving.

For step 1 above, the process shown in FIG. 5 of the accompanying drawings is proposed. This is a flow chart illustrating the proposed process for using the static radar sensor accelerometer measurements following ignition on for checking accelerometer alignment in comparison with previously stored values, and determining any pitch and roll angular alignment changes for subsequent in-motion accelerometer measurement corrections.

In this method, the vehicle stops (step 10) and the current values of the acceleration in the three axes aₓ₀, a_{y0} and a_{z0} at zero speed are stored in non-volatile member (step 12). The vehicle ignition is then turned off (step 14) and the vehicle 3 is left parked 16.

The ignition is then turned on again some time later (step 18). We refer to aₓ₀(t), a_{y0}(t) and a_{z0}(t) as the measurements of acceleration (due to gravity since the vehicle is stationary: v=0 m/s) from the three accelerometer 4 axes at some time t seconds after ignition on, and δaₓ₀(t), δa_{y0}(t) and δ_{z0}(t) are the differences between these measurements and the previously stored values aₓ₀, a_{y0} and a_{z0} from the radar sensor accelerometer.

If δaₓ₀(t), δa_{y0}(t) and δa_{z0}(t) are less than some threshold (step 20), then this implies that no misalignment of the radar sensor has occurred since the previous ignition off: in this case, the new values of aₓ₀(t), a_{y0}(t) and a_{z0}(t) are simply stored as the new “reference” values for future comparisons (step 22).

If δaₓ₀(t), δa_{y0}(t) and δa_{z0}(t) are more than the threshold, then aₓ₀(t), a_{y0}(t) and a_{z0}(t) from the accelerometer 4 are compared with the corresponding signals from the vehicle accelerometer 6. If the corresponding values match to within some tolerance (step 24), then it is inferred that the apparent rotation of the radar sensor accelerometer is actually only the result of some misalignment of the whole vehicle body (perhaps the driver put something heavy in the boot, for example): in this case, the new values of aₓ₀(t), a_{y0}(t) and a_{z0}(t) are again simply stored as the new “reference” values for future comparisons, since no separate misalignment of the radar sensor itself has occurred.

If the readings from the two accelerometers are found not to match, then it is inferred that misalignment of the radar sensor module has occurred (step 26). In this case, prior to the vehicle moving off, the degree of pitch (θ) and roll (φ) misalignment(s) are determined from the measurements of aₓ₀(t), a_{y0}(t) and a_{z0}(t) (using an analytical process). Appropriate corrections for these misalignments, if any, can then be applied immediately, prior to the vehicle moving off.

Then, after the vehicle moves off, the degree of any additional azimuthal (yaw) misalignment (ψ) is determined from comparison of the measurements of lateral linear acceleration from the two accelerometers 4, 6.

1. Apparatus for detecting misalignment of a radar unit of a vehicle, the apparatus comprising:
an accelerometer arranged to determine the acceleration of the radar unit along three axes, and having an output for a signal indicative of the acceleration; and
a processor arranged coupled to the output of the accelerometer;
in which the processor is arranged to determine the misalignment based on the acceleration measured by the accelerometer, and in which the determination of the misalignment is made:
about two axes, if the vehicle is stationary; and
about a third axis perpendicular to the two axes when the vehicle is moving.

2. The apparatus of claim 1, in which, in use, the two axes are perpendicular to each other, and the third axis is generally vertical.

3. The apparatus of claim 1, in which the processor is arranged so as to not determine the misalignment about the third axis when the vehicle is stationary.

4. The apparatus of claim 1, in which the processor is arranged so as to determine the misalignment about the two axes when the vehicle is moving.

5. The apparatus of claim 1, in which the processor has an input for an indication whether the vehicle is moving, such as the output of a vehicle speed sensor or is to determine from the accelerometer when the vehicle is moving.

6. A vehicle having a radar unit and the apparatus of claim 1 attached thereto, in which the accelerometer is attached to or integrated in the radar unit.

7. The vehicle of claim 6, provided with a further accelerometer coupled to the vehicle and able to determine the acceleration of the vehicle about three axes, with an output of the further accelerometer being coupled to the processor and the processor arranged to determine the misalignment based upon the acceleration of the vehicle.

8. A method of detecting misalignment of a radar unit of a vehicle, comprising determining the acceleration of the radar unit along three axes, and determining the misalignment based on the acceleration, in which the determination of the misalignment is made:
about two axes, if the vehicle is stationary; and
about a third axis perpendicular to the two axes when the vehicle is moving.

9. The method of claim 8, comprising not determining the misalignment about the third axis when the vehicle is stationary.

10. The method of claim 8, comprising determining the misalignment about the two axes when the vehicle is moving.

11. The method of claim 8, comprising determining from the accelerometer when the vehicle is moving, or using a vehicle speed sensor to so determine.

12. The method of claim 8, comprising using a further accelerometer coupled to the vehicle to determine the acceleration of the vehicle about three axes, and determining the misalignment based upon the acceleration of the vehicle.
